(19) United States
(12) Patent Application Publication
(10) Pub. No.: US 2026/0261827 A1
(43) Pub. Date: Sep. 3, 2026

(54) SYSTEM AND METHOD FOR MANAGING MOBILE ORIGINATED MESSAGE IN NETWORK

(71) Applicant: JIO PLATFORMS LIMITED, Ahmedabad, Gujarat (IN)

(72) Inventors: Aayush BHATNAGAR, Navi Mumbai, Maharashtra (IN); Hardik Navinbhai BAVISHI, Navi Mumbai, Maharashtra (IN); Sandeep BISHT, Kalyan, Thane, Maharashtra (IN); Kumar Gaurav SINGH, Panvel, Mahrashtra (IN); Nilesh SANAS, Navi Mumbai, Maharashtra (IN); Amit Kumar SINGH, Kalyan East, Maharashtra (IN); Raghvendra BHUSHAN, Kalyan, Thane, Maharashtra (IN); Mangesh Shantaram KALE, Navi Mumbai, Maharashtra (IN); Gaurav JAIN, Mumbai, Maharashtra (IN); Anurag SINHA, Mumbai, Maharashtra (IN)

(73) Assignee: JIO PLATFORMS LIMITED, Ahmedabad, Gujarat (IN)

(21) Appl. No.: 18/993,085

(22) PCT Filed: May 7, 2024
(86) PCT No.: PCT/IN2024/050492

§ 371 Date: Jan. 10, 2025

(30) Foreign Application Priority Data
May 30, 2023 (IN) 202321037311

(51) Int. Cl. H04W 4/12; H04W 8/12

(52) U.S. Cl. CPC H04W 4/12; H04W 8/12

(57) ABSTRACT

The present disclosure relates to a method for managing a mobile originated (MO) message for a user equipment (UE) (102). When it is determined that the UE (102) is connected to a first network, sending an MO message to a session management function (SMF) (104), forwarding the received MO message to a network exposure function (NEF) (106), forwarding the MO message to an application function (AF) (112), sending an acknowledgement signal to the NEF (106) and forwarding the acknowledgement signal to the UE (102). When it is determined that the UE (102) is attached to the second network, sending an MO message to a mobility management entity (MME) (110), forwarding the received MO message to a service capability exposure function (SCEF) (108), forwarding the MO message to the NEF (106), sending an acknowledgement signal to the NEF (106), and delivering the acknowledgement signal to the UE (102).

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

Embodiments of the present disclosure generally relate to wireless communications technology. In particular, the present disclosure relates to a system and a method for managing data transfer in a network to minimise failure during transfer of data in the network.

### BACKGROUND OF INVENTION

The following description of related art may be intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In some cases, a cellular Internet of Things (CIoT) is a scenario where a large number of devices may be served by a wireless network. The devices may range from stationary devices deep in basements to devices that have limited mobility speed. The devices may send and/or receive infrequent, small amounts of data. Examples of CIoT devices may include smart utility meters such as gas, water, or electric meters that may autonomously report utility usage to the utility provider via the wireless network. Another example of CIoT devices may include environmental monitoring sensors that may be placed randomly in a geographical area to monitor air or water quality.

In some cases, mobile originated (MO) short message service (SMS) may be used for a device to send and/or receive a short message up to 140 bytes/octets in length. The infrequent and small amount of CIoT data may be included in the short message and delivered to the network by SMS.

The MO messages are generally exchanged based on 3GPP protocols. 3GPP standards evolve with time and cover aspects of integration and features that a node of the network (such as 4G or 5G) supports.

However, lack of explicit description of interaction between 4G nodes like Service Capability Exposure Function (SCEF) and Network Exposure Function (NEF) may lead to designing flaws. While the 3GPP may indicate sparsely about interactions between Application Function (AF), NEF, and SCEF through the Common Application Programming Interface (API) Framework (CAPIF), the description lacks how CAPIF selects between NEF and SCEF. Moreover, AF needs to support N33 and T8 APIs.

There is, therefore, a requirement in the art for a means to address the issue of mitigating the complexity of transfer of data elements between network elements.

### DEFINITION

As used in the present disclosure, the following terms are generally intended to have the meaning as set forth below, except to the extent that the context in which they are used to indicate otherwise.

The term SMF as used herein, refers to a Session Management Function. The SMF is responsible for establishing, maintaining, and terminating user sessions in the 5G core network. The SMF is a functional module that is responsible for interacting with decoupled data plane, creating, updating, and removing Protocol Data Unit (PDU) sessions and managing session context with a User Plane Function (UPF).

The term AF as used herein, refers Application Function. The AF is a control plane function within 5G core network, provides application services to the subscriber. For example, it can be for video streaming service. If an AF is trusted, it may interact directly with 5GC network functions or if it is third party, then it may interact with an NEF.

The term NEF as used herein, refers to a Network Exposure Function. The NEF is among the fundamental capabilities natively built-in in the 5G network. It allows carriers to securely handle valuable data coming from Application Functions (AF) and enables optimal allocation and utilization of resources. The NEF provides signaling scenarios to allow a controlled and secure way of exchanging information to and from an external application. The NEF facilitates secure, robust, developer-friendly access to the exposed network services and capabilities of 5G network, enabling third-party developers and enterprises to create and tailor composite or specialized network services on-demand.

The term SCEF as used herein, refers to a Service Capability Exposure Function. The SCEF is a new network element that securely exposes the servers and capabilities provided by 3GPP network interfaces. Some functions included with SCEF include non-IP data delivery (NIDD) for low power devices.

The term MME as used herein, refers to Mobile Management Entity. The MME is a functional module which presents a key control node for the Long-Term Evolution (LTE) access network, manages UE access network and mobility, as well as establishes the bearer path for UEs. The MME may also be concerned with the bearer activation/deactivation process. In addition, the MME may be responsible for selecting the Serving-Gateway (S-GW) for a UE at the initial join and at time of intra-LTE handover. The MME is in charge of authenticating the user as well as the generation and allocation of temporary identities to UEs.

The term AMF as used herein, refers to an Access and Mobility Management Function. The AMF may refer a functional module which terminates the control plane of different access networks onto the 5G Core Network (5GC) and control which user equipments (UEs) can access the 5GC to exchange traffic with Data Networks (DNs).

### OBJECTS OF THE DISCLOSURE

An object of the present disclosure is to provide a technique to manage mobile originated (MO) messages in any of 4G or 5G networks.

Another object of the present disclosure is to reduce complexity of transfer of data between various network elements in a network.

Another object of the present disclosure is to provide an interface between NEF and SCEF.

Another object of the present disclosure is to save session management (SM)-context in a database to be used.

Another object of the present disclosure is to enhance the nodes in communication.

Yet another object of the present disclosure is to improvise the network capabilities.

### SUMMARY

In an exemplary embodiment, the present invention discloses a method for managing a mobile originated (MO) message for a user equipment (UE) moving between a first network and a second network. The method comprising determining if the UE is connected to the first network or to the second network. When it is determined that the UE is connected to the first network, then the method comprising sending, by the UE, an MO message to a session management function (SMF). The method comprising forwarding, by the SMF, the received MO message to a network exposure function (NEF). The method comprising forwarding, by the NEF, the MO message to an application function (AF). The method comprising sending, by the AF, an acknowledgement signal to the NEF after receiving the MO message. The method comprising forwarding, by the NEF, the acknowledgement signal to the UE via the SMF. When it is determined that the UE is attached to the second network, then the method comprising sending, by the UE, an MO message to a mobility management entity (MME). The method comprising forwarding, by the MME the received MO message to a service capability exposure function (SCEF). The method comprising forwarding, by the SCEF, the MO message to the NEF. The method comprising forwarding, by the NEF, the MO message to an application function (AF). The method comprising sending, by the AF, an acknowledgement signal to the NEF after receiving the MO message. The method comprising forwarding, by the NEF, the acknowledgement signal to the SCEF and delivering, by the SCEF, the acknowledgement signal to the UE via the MME.

In some embodiments, the first network and the second network are provided with a reliable data services (RDS) support indication.

In some embodiments, the UE sends the MO message to the SMF after performing a successful attach procedure with the first network.

In some embodiments, the method further comprising creating, by the SMF, a session management (SM) context on the NEF during the attach procedure.

In some embodiments, the method further comprising searching, by the NEF, an endpoint of the AF for forwarding the MO message to the AF.

In some embodiments, the NEF checks the SM context and a Non-Internet Protocol Data Delivery (NIDD) configuration mapping for searching the endpoint of the AF.

In some embodiments, the NIDD configuration includes an address of the AF for each UE available in the first network and the second network.

In some embodiments, the NEF forwards the acknowledgement signal to the UE via the SMF as per the SM context.

In some embodiments, the NEF forwards the acknowledgement signal to the UE after determining that the UE indicated support for the RDS during the attach procedure.

In some embodiments, the method further comprising creating, by the MME, a session management (SM) context on the SCEF during the attach procedure.

In some embodiments, the SCEF forwards the MO message to the NEF through a predefined interface.

In some embodiments, the NEF forwards the acknowledgement signal to the SCEF as per the SM context over the predefined interface.

In some embodiments, the SCEF delivers the acknowledgement signal to the UE via the MME after determining that the UE indicated support for the RDS during the attach procedure.

In some embodiments, the first network is a 5G network and the second network is a 4G network.

In an exemplary embodiment, the present invention discloses a system for managing a mobile originated (MO) message for a user equipment (UE) moving between a first network and a second network. The system is configured to determine if the UE is connected to the first network or to the second network. When it is determined that the UE is connected to the first network, then the system is configured to send, by the UE, an MO message to a session management function (SMF). The system is configured to forward, by the SMF, the received MO message to a network exposure function (NEF). The system is configured to forward, by the NEF, the MO message to an application function (AF). The system is configured to send, by the AF, an acknowledgement signal to the NEF after receiving the MO message. The system is configured to forward, by the NEF, the acknowledgement signal to the UE via the SMF. When it is determined that the UE is attached to the second network, then the system is configured to send, by the UE, an MO message to a mobility management entity (MME). The system is configured to forward, by the MME the received MO message to a service capability exposure function (SCEF). The system is configured to forward, by the SCEF, the MO message to the NEF. The system is configured to forward, by the NEF, the MO message to an application function AF. The system is configured to send, by the AF, an acknowledgement signal to the NEF after receiving the MO message. The system is configured to forward, by the NEF, the acknowledgement signal to the SCEF and deliver, by the SCEF, the acknowledgement signal to the UE via the MME.

In some embodiments, the first network and the second network are provided with a reliable data services (RDS) support indication.

In some embodiments, the UE sends the MO message to the SMF after performing a successful attach procedure with the first network.

In some embodiments, the system is configured to create, by the SMF, a session management (SM) context on the NEF during the attach procedure.

In some embodiments, the system is configured to search, by the NEF, an endpoint of the AF for forwarding the MO message to the AF.

In some embodiments, the NEF checks the SM context and a Non-Internet Protocol Data Delivery (NIDD) configuration mapping for searching the endpoint of the AF.

In some embodiments, the NIDD configuration includes an address of the AF for each UE available in the first network and the second network.

In some embodiments, the NEF forwards the acknowledgement signal to the UE via the SMF as per the SM context.

In some embodiments, the NEF forwards the acknowledgement signal to the UE after determining that the UE indicated support for the RDS during the attach procedure.

In some embodiments, the system is configured to create, by the MME, a session management (SM) context on the SCEF during the attach procedure.

In some embodiments, the SCEF forwards the MO message to the NEF through a predefined interface.

In some embodiments, the NEF forwards the acknowledgement signal to the SCEF as per the SM context over the predefined interface.

In some embodiments, the SCEF delivers the acknowledgement signal to the UE via the MME after determining that the UE indicated support for the RDS during the attach procedure.

In some embodiments, the first network is a 5G network and the second network is a 4G network.

In an exemplary embodiment, the present invention discloses a user equipment (UE) moving between a first network and a second network. The first network and the second network comprising one or more network elements for managing a mobile originated (MO) message for the UE. The one or more network elements configured for determining if the UE is connected to the first network or the second network. When it is determined that the UE is connected to the first network, receiving, from the UE, an MO message by a session management function (SMF). The one or more network elements configured for forwarding, by the SMF, the received MO message to a network exposure function (NEF) and forwarding, by the NEF, the MO message to an application function (AF). The one or more network elements configured for sending, by the AF, an acknowledgement signal to the NEF after receiving the MO message and forwarding, by the NEF, the acknowledgement signal to the UE via the SMF. When it is determined that the UE is attached to the second network, receiving, from the UE, an MO message by a mobility management entity (MME). The one or more network elements configured for forwarding, by the MME, the received MO message to a service capability exposure function (SCEF). The one or more network elements configured for forwarding, by the SCEF, the MO message to the NEF, and forwarding, by the NEF, the MO message to an application function AF. The one or more network elements configured for sending, by the AF, an acknowledgement signal to the NEF after receiving the MO message, forwarding, by the NEF, the acknowledgement signal to the SCEF and delivering, by the SCEF, the acknowledgement signal to the UE via the MME.

The foregoing general description of the illustrative embodiments and the following detailed description thereof are merely exemplary aspects of the teachings of this disclosure and are not restrictive.

### BRIEF DESCRIPTION OF THE DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1A illustrates an exemplary system architecture (100A) for implementing a proposed system, in accordance with an embodiment of the present disclosure.

FIG. 1B illustrates an exemplary sequence diagram (100B) representing different call flows in a network, in accordance with an embodiment of the present disclosure.

FIG. 2 illustrates an exemplary computer system in which or with which the proposed system for the sequence drawing may be implemented, in accordance with an embodiment of the present disclosure.

FIG. 3 illustrates an exemplary flow diagram (300) for a method for managing a mobile originated (MO) message for a user equipment (UE) moving between a first network and a second network, in accordance with an embodiment of the present disclosure.

The foregoing shall be more apparent from the following more detailed description of the disclosure.

### LIST OF REFERENCE NUMERALS

100A—System architecture
102—User equipment (UE)
104—Session management function (SMF)
106—Network exposure function (NEF)
108—Service capability exposure function (SCEF)
110—Mobility management entity (MME)
112—Application function (AF)
114-1, 114-2—Internet of things (IOT) device
116—System
118—Receiving unit
120—Processing unit
122—Database
124—Interfacing unit
100B—Flow Diagram
200—A computer system
210—External storage device
220—Bus
230—Main memory
240—Read only memory
250—Mass storage device
260—Communication port(s)
270—Processor
300—Flow Diagram

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Certain terms and phrases have been used throughout the disclosure and will have the following meanings in the context of the ongoing disclosure.

The term “3GPP” is a 3rd Generation Partnership Project or 3GPP and is a collaborative project between a group of telecommunications associations with the initial goal of developing globally applicable specifications for Third Generation (3G) mobile systems. 3GPP specifications cover cellular telecommunications technologies, including radio access, core network, and service capabilities, which provide a complete system description for mobile telecommunications. The 3GPP specifications also provide hooks for non-radio access to the core network, and for networking with non-3GPP networks.

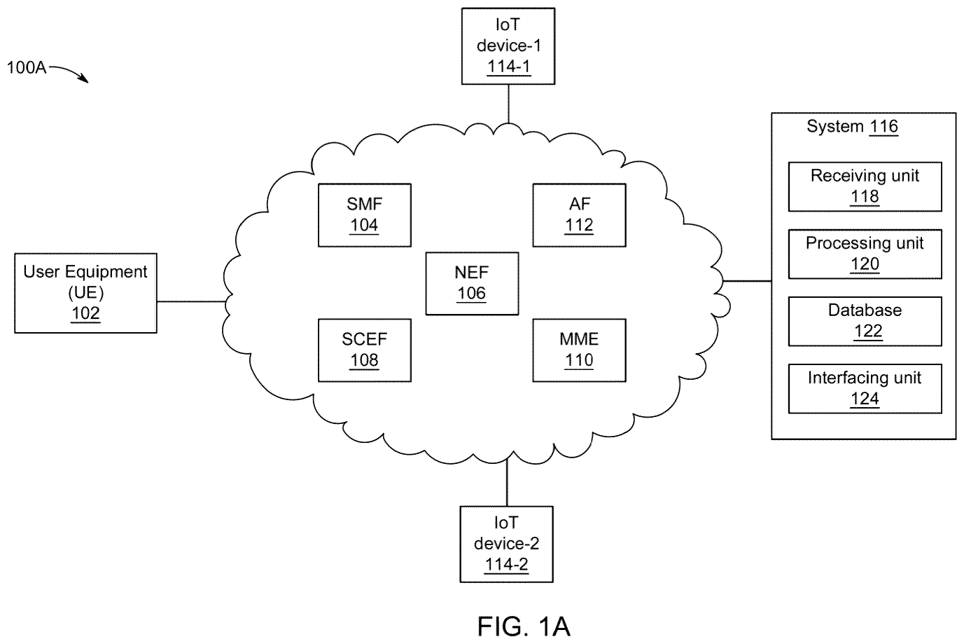

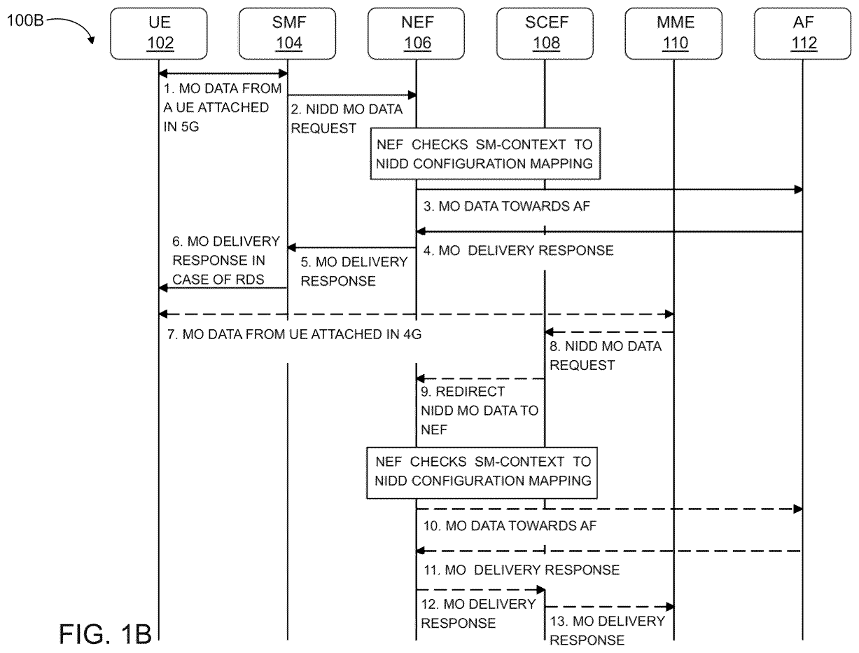

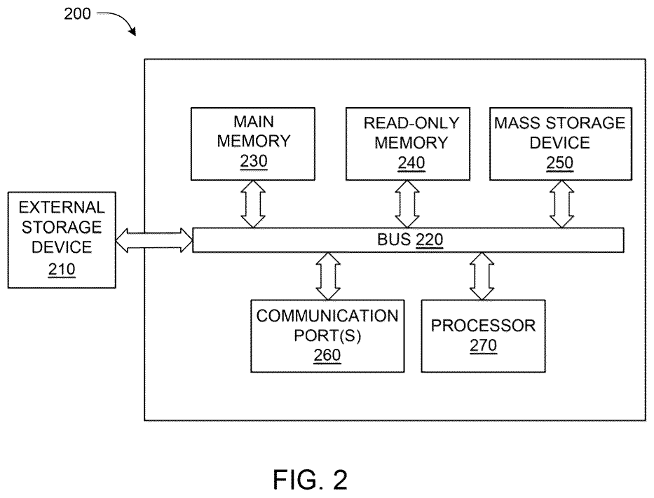

Various embodiments of the present disclosure will be explained with reference to FIGS. 1A, 1B and 2.

FIG. 1A illustrates an exemplary network architecture (100A) for implementing a proposed system, in accordance with an embodiment of the present disclosure.

In an aspect, the network architecture (100A) includes a user equipment (UE) (102) connected to the network (a first network or a second network). The network may be a 4G network or a 5G network. The UE (102) initiates at least one request message towards the network and receives at least one response message from the network. The network may include a plurality of network elements. For example, the network may include SMF (104), NEF (106), SCEF (108), MME (110), and AF (112). The network may be further connected to a plurality of Internet of Things (IoT) devices such as IoT device-1 (114-1) and IoT device-2 (114-2). The UE (102) may communicate with a system (116), through a network. The network enables the UE (102) to communicate with other devices in the network architecture (100A) and/or with the system (116). The network may include a wireless card or some other transceiver connection to facilitate this communication. The system (116) includes a receiving unit (118), a processing unit (120), a database (122), and an interfacing unit (124). The receiving unit (118) is configured to receive a connection request from the UE (102). The receiving unit (118) is configured to communicate an acknowledgment of the connection request to the UE (102) and is further configured to transmit a plurality of signals to one or more network elements in response to the connection.

The processing unit (120) is coupled to the receiving unit (118). The processing unit (120) may be implemented as one or more microprocessors, microcomputers, microcontrollers, digital signal processors, central processing units, logic circuitries, and/or any devices that process data based on operational instructions. Among other capabilities, the processing unit (120) may be configured to fetch and execute computer-readable instructions stored in a memory of the system (116). The memory may be configured to store one or more computer-readable instructions or routines in a non-transitory computer readable storage medium, which may be fetched and executed to create or share data packets over a network service. The memory may comprise any non-transitory storage device including, for example, volatile memory such as random-access memory (RAM), or non-volatile memory such as erasable programmable read-only memory (EPROM), flash memory, and the like. The database (122) may store information such as MO data, NIDD configurations, and the like.

In an embodiment, the interfacing unit (124) may comprise a variety of interfaces, for example, interfaces for data input and output devices (I/O), storage devices, and the like. The interfacing unit (124) may facilitate communication through the system (116). The interfacing unit (124) may also provide a communication pathway for one or more components of the system (116).

In an embodiment, the user device (UE) (102) may include, but not be limited to, a mobile, a laptop, etc. Further, the user device (102) may include one or more in-built or externally coupled accessories including, but not limited to, a visual aid device such as a camera, audio aid, microphone, or keyboard. Furthermore, the user device (102) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the user (102) such as a touchpad, touch-enabled screen, electronic pen, and the like may be used. In an embodiment, the network may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

FIG. 1B illustrates an exemplary sequence diagram (100B) representing different call flows in a network, in accordance with an embodiment of the present disclosure. Specifically, the sequence diagram (100B) represents a management of mobile originated (MO) messages in a network.

A UE (102) is configured in the 5G network and is provided with reliable data services (RDS) support indication. The reliable data services in a telecommunication network refer to the ability of the network to consistently deliver high-quality, low-latency, and uninterrupted data connectivity to the users.

At step 1, the UE (102) may send an MO data (message) to a SMF (104) on successful attachment with the 5G network.

At step 2, the SMF (104) may receive the MO data from the UE (102), and subsequently, forward the MO data towards an NEF (106) on which the

SMF (104) created a session management (SM)-context during the attachment procedure. The SM context is created by SMF, or in V-SMF in home routed (HR) roaming scenarios, for a Packet Data Unit (PDU) session. The SMF (104) may send a Non-Internet Protocol (IP) Data Delivery (NIDD) data request to the NEF. The NIDD refers to a communication mechanism used in cellular networks to transmit non-IP (Internet Protocol) data. In traditional cellular networks, IP is the primary protocol used for data communication. However, there are cases where non-IP data needs to be transmitted efficiently and securely, such as for specialized applications or services. The NIDD provides an alternative method for delivering non-IP data over cellular networks. It allows the transmission of data using protocols other than IP, enabling efficient delivery of non-IP traffic. Further, The NEF (106) may be further configured to check the SM-context to Non-Internet Protocol (IP) Data Delivery (NIDD) configuration mapping to search for an AF (112) endpoint.

At step 3, once the AF endpoint may be determined, the NEF (106) may be configured to forward the MO message to the AF (112).

At step 4, the AF (112) may be further adapted to acknowledge receipt of the MO message (MO delivery response). The NEF (106) may subsequently receive the acknowledgement from the AF (112).

At step 5, the NEF (106) forwards the acknowledgement to the SMF (104). The SMF (104) further forwards the acknowledgement to the UE (102) using the SM-context if the UE (102) may have indicated support for RDS.

At step 6, the SMF (104) sends a MO delivery response to the UE (102) in case of RDS. In an aspect, the SMF (104) sends a RDS based response to the UE (102). In some embodiments, the UE (102) may be configured in a 4G network and may be provided with RDS support.

At step 7, the UE (102) may send the MO data towards an MME (110).

At step 8, the MME (110) may send a NIDD MO data request towards the SCEF (108).

At step 9, the SCEF (108) may redirect the received NIDD MO data request to the NEF (106).

In an embodiment the MME (110) may be configured to forward the MO data (message) to an SCEF (108) instance on which it may have created the SM-context during the attachment procedure. Further, the SCEF (108) may be configured to forward the MO message to the NEF (106) over an interface, while delivering the MO message to the AF (112). The NEF (106) may be further configured to check the SM-context to NIDD configuration mapping to search for an AF (112) endpoint.

At step 10, once the AF (112) endpoint may be determined, the NEF (106) may be configured to forward the MO message to the AF (112).

At step 11, the AF (112) may be further adapted to acknowledge receipt of the MO message and forwards a MO delivery response towards the NEF. The NEF (106) may subsequently receive the MO delivery response (acknowledgement) from the AF (112).

At step 12, the NEF (106) may forward the MO delivery response (acknowledgement) to the SCEF (108) over the predefined interface using the SM-context.

At step 13, the MO delivery response (acknowledgment) may be sent from the SCEF (108) towards the MME (110). The MME (110) may further deliver the MO delivery response (acknowledgement) to the UE (102)) if the UE (102) may have indicated support for RDS.

The NEF (106) may be configured to check SM-context to NIDD configuration mapping and redirect NIDD MO data to the NEF (106). When the UE (102) is attached to 5G, the SM-context may be created on the NEF (106) by the SMF (104). Similarly, when the UE (102) is attached to 4G, the SM-context may be created by the MME (110) on the SCEF (108).

The SM-Context may be saved in a database. The NIDD configuration may contain the address of the AF (112) for every UE (102). Thus, whenever the NEF (106) may receive an MO message, it may check the destination address of the AF (112), as per the NIDD configuration data and corresponding UE (102) network.

Further, whenever the SCEF (108) may receive the MO data, it may not directly forward it to the AF (112); however, the MO message may be forwarded to the NEF (106) over the predefined interface. Hence, data transfer complexity is reduced for interworking scenarios.

In an aspect, the present system and method for managing mobile originated (MO) message in a network is configured to be employed in a 5G telecommunication network. The present system and method provide management of messages and communication between the network devices.

In an embodiment, the present disclosure provides a means to manage mobile originated (MO) messages in any of 4G or 5G networks. The present disclosure provides a means to reduce complexity of transfer of data between various network elements in a network. The present disclosure provides a means to save session management (SM)-context in a database to be used.

FIG. 2 illustrates an exemplary computer system (200) in which or with which a proposed system for the sequence drawing (100B) may be implemented, in accordance with an embodiment of the present disclosure.

As shown in FIG. 2, the computer system (200) may include an external storage device (210), a bus (220), a main memory (230), a read-only memory (240), a mass storage device (250), a communication port(s) (260), and a processor (270). A person skilled in the art will appreciate that the computer system (200) may include more than one processor and communication ports. The processor (270) may include various modules associated with embodiments of the present disclosure. The communication port(s) (260) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (260) may be chosen depending on a network, such as a Local Area Network (LAN), Wide Area Network (WAN), or any network to which the computer system (200) connects.

In an embodiment, the main memory (230) may be Random Access Memory (RAM), or any other dynamic storage device commonly known in the art. The read-only memory (240) may be any static storage device(s) e.g., but not limited to, a Programmable Read Only Memory (PROM) chip for storing static information e.g., start-up or basic input/output system (BIOS) instructions for the processor (270). The mass storage device (250) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (220) may communicatively couple the processor(s) (270) with the other memory, storage, and communication blocks. The bus (220) may be, e.g., a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (270) to the computer system (200).

In another embodiment, operator, and administrative interfaces, e.g., a display, keyboard, and cursor control device may also be coupled to the bus (220) to support direct operator interaction with the computer system (200). Other operator and administrative interfaces can be provided through network connections connected through the communication port(s) (260). Components described above are meant only to exemplify various possibilities. In no way should the aforementioned exemplary computer system (200) limit the scope of the present disclosure.

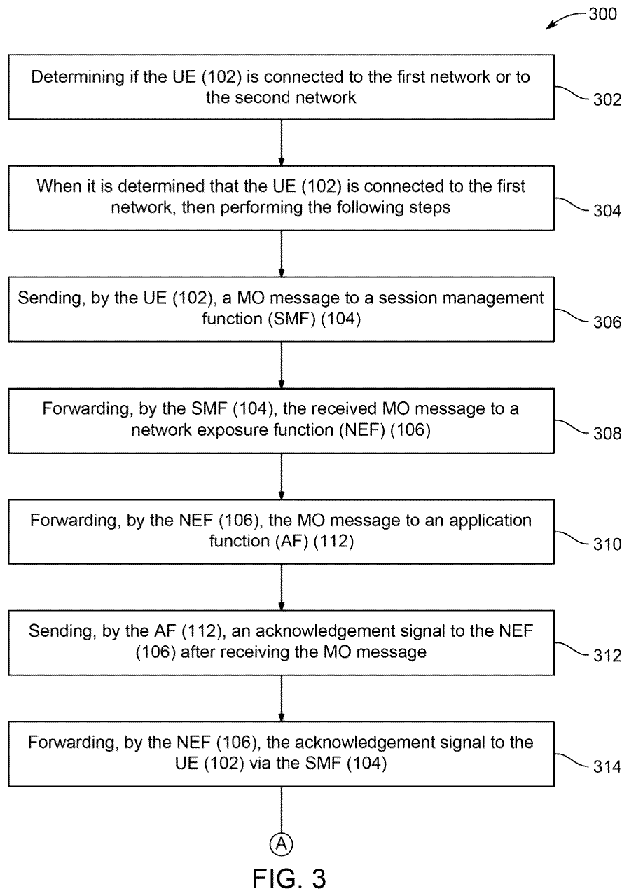

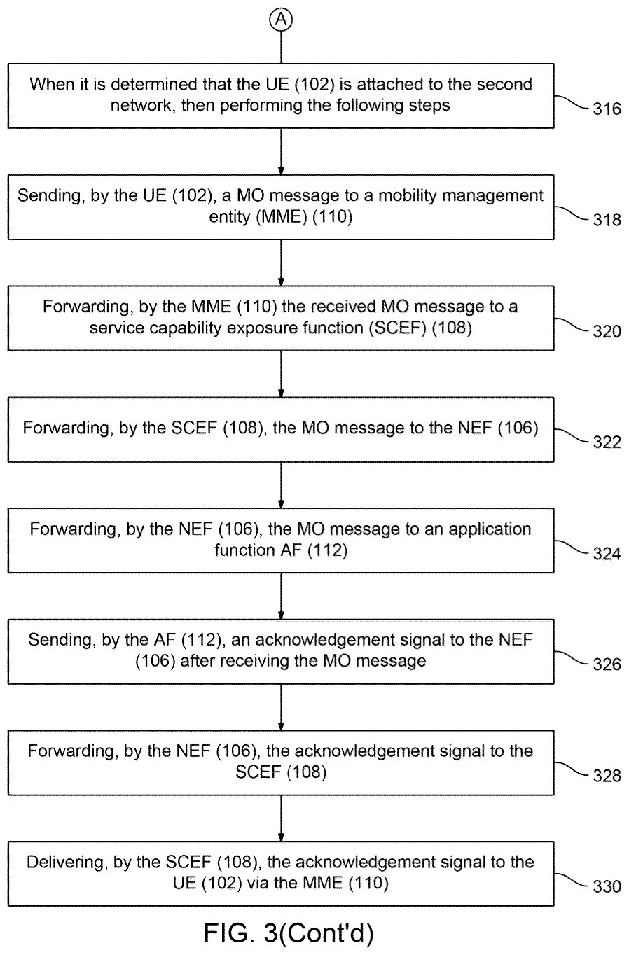

FIG. 3 illustrates an exemplary flow diagram (300) for a method for managing a mobile originated (MO) message for a user equipment (UE) moving between a first network and a second network. The method comprising the following steps:

At 302, the method comprising determining if the UE is connected to the first network or to the second network.

At 304, when it is determined that the UE is connected to the first network, then performing the following steps:

At 306 the method comprising sending, by the UE, an MO message to a session management function (SMF).

At 308, the method comprising forwarding, by the SMF, the received MO message to a network exposure function (NEF).

At 310, the method comprising forwarding, by the NEF, the MO message to an application function (AF).

At 312, the method comprising sending, by the AF, an acknowledgement signal to the NEF after receiving the MO message.

At 314, the method comprising forwarding, by the NEF, the acknowledgement signal to the UE via the SMF.

At 316, When it is determined that the UE is attached to the second network, then the method comprising

At 318, the method comprising sending, by the UE, an MO message to a mobility management entity (MME).

At 320, the method comprising forwarding, by the MME the received MO message to a service capability exposure function (SCEF).

At 322, the method comprising forwarding, by the SCEF, the MO message to the NEF.

At 324, the method comprising forwarding, by the NEF, the MO message to an application function AF.

At 326, the method comprising sending, by the AF, an acknowledgement signal to the NEF after receiving the MO message.

At 328, the method comprising forwarding, by the NEF, the acknowledgement signal to the SCEF,

At 330, the method comprising delivering, by the SCEF, the acknowledgement signal to the UE via the MME.

In some embodiments, the first network and the second network are provided with a reliable data services (RDS) support indication.

In some embodiments, the UE sends the MO message to the SMF after performing a successful attach procedure with the first network.

In some embodiments, the method further comprising creating, by the SMF, a session management (SM) context on the NEF during the attach procedure.

In some embodiments, the method further comprising searching, by the NEF, an endpoint of the AF for forwarding the MO message to the AF.

In some embodiments, the NEF checks the SM context and a Non-Internet Protocol Data Delivery (NIDD) configuration mapping for searching the endpoint of the AF.

In some embodiments, the NIDD configuration includes an address of the AF for each UE available in the first network and the second network.

In some embodiments, the NEF forwards the acknowledgement signal to the UE via the SMF as per the SM context.

In some embodiments, the NEF forwards the acknowledgement signal to the UE after determining that the UE indicated support for the RDS during the attach procedure.

In some embodiments, the method further comprising creating, by the MME, a session management (SM) context on the SCEF during the attach procedure.

In some embodiments, the SCEF forwards the MO message to the NEF through a predefined interface.

In some embodiments, the NEF forwards the acknowledgement signal to the SCEF as per the SM context over the predefined interface.

In some embodiments, the SCEF delivers the acknowledgement signal to the UE via the MME after determining that the UE indicated support for the RDS during the attach procedure.

In some embodiments, the first network is a 5G network and the second network is a 4G network.

In an exemplary embodiment, the present invention discloses a system for managing a mobile originated (MO) message for a user equipment (UE) moving between a first network and a second network. The system is configured to determine if the UE is connected to the first network or to the second network. When it is determined that the UE is connected to the first network, then the system is configured to send, by the UE, an MO message to a session management function (SMF). The system is configured to forward, by the SMF, the received MO message to a network exposure function (NEF). The system is configured to forward, by the NEF, the MO message to an application function (AF). The system is configured to send, by the AF, an acknowledgement signal to the NEF after receiving the MO message. The system is configured to forward, by the NEF, the acknowledgement signal to the UE via the SMF. When it is determined that the UE is attached to the second network, then the system is configured to send, by the UE, an MO message to a mobility management entity (MME). The system is configured to forward, by the MME the received MO message to a service capability exposure function (SCEF). The system is configured to forward, by the SCEF, the MO message to the NEF. The system is configured to forward, by the NEF, the MO message to an application function AF. The system is configured to send, by the AF, an acknowledgement signal to the NEF after receiving the MO message. The system is configured to forward, by the NEF, the acknowledgement signal to the SCEF and deliver, by the SCEF, the acknowledgement signal to the UE via the MME.

In an exemplary embodiment, the present invention discloses a user equipment (UE) moving between a first network and a second network. The first network and the second network comprising one or more network elements for managing a mobile originated (MO) message for the UE. The one or more network elements configured for determining if the UE is connected to the first network or the second network. When it is determined that the UE is connected to the first network, receiving, from the UE, an MO message by a session management function (SMF). The one or more network elements configured for forwarding, by the SMF, the received MO message to a network exposure function (NEF) and forwarding, by the NEF, the MO message to an application function (AF). The one or more network elements configured for sending, by the AF, an acknowledgement signal to the NEF after receiving the MO message and forwarding, by the NEF, the acknowledgement signal to the UE via the SMF. When it is determined that the UE is attached to the second network, receiving, from the UE, an MO message by a mobility management entity (MME). The one or more network elements configured for forwarding, by the MME, the received MO message to a service capability exposure function (SCEF). The one or more network elements configured for forwarding, by the SCEF, the MO message to the NEF, and forwarding, by the NEF, the MO message to an application function AF. The one or more network elements configured for sending, by the AF, an acknowledgement signal to the NEF after receiving the MO message, forwarding, by the NEF, the acknowledgement signal to the SCEF and delivering, by the SCEF, the acknowledgement signal to the UE via the MME.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### ADVANTAGES OF THE DISCLOSURE

The present disclosure provides a means to manage mobile originated (MO) messages in any of 4G or 5G networks.

The present disclosure provides a means to reduce complexity of transfer of data between various network elements in a network.

The present disclosure provides an interface between Network Exposure Function (NEF) and Service Capability Exposure Function (SCEF).

The present disclosure provides a means to save session management (SM)-context in a database to be used.

The invention mitigates managing multiple protocols between network elements.

The invention mitigates data transfer mechanisms between network elements.

The invention mitigates data transfer mechanisms/certificates/ security related protocols/end point IP connection details and data connection management between network elements.

1. A method for managing a mobile originated (MO) message for a user equipment (UE) moving between a first network and a second network, the method comprising:
determining if the UE is connected to the first network or to the second network;
when it is determined that the UE is connected to the first network, then performing following steps:
sending, by the UE, an MO message to a session management function (SMF);
forwarding, by the SMF, the received MO message to a network exposure function (NEF);
forwarding, by the NEF, the MO message to an application function (AF);
sending, by the AF, an acknowledgement signal to the NEF after receiving the MO message;
forwarding, by the NEF, the acknowledgement signal to the UE via the SMF;
when it is determined that the UE is attached to the second network, then performing following steps:
sending, by the UE, an MO message to a mobility management entity (MME);
forwarding, by the MME, the received MO message to a service capability exposure function (SCEF);
forwarding, by the SCEF, the MO message to the NEF;
forwarding, by the NEF, the MO message to an application function AF;
sending, by the AF, an acknowledgement signal to the NEF after receiving the MO message;
forwarding, by the NEF, the acknowledgement signal to the SCEF; and
delivering, by the SCEF, the acknowledgement signal to the UE via the MME.

2. (canceled)

3. (canceled)

4. The method as claimed in claim 1, further comprising creating, by the SMF, a session management (SM) context on the NEF during the attach procedure.

5. The method as claimed in claim 1, further comprising searching, by the NEF, an endpoint of the AF for forwarding the MO message to the AF, and wherein the NEF checks the SM context and a Non-Internet Protocol Data Delivery (NIDD) configuration mapping for searching the endpoint of the AF.

6. (canceled)

7. (canceled)

8. The method as claimed in claim 1, wherein the NEF forwards the acknowledgement signal to the UE via the SMF per the SM context.

9. The method as claimed in claim 8, wherein the NEF forwards the acknowledgement signal to the UE after determining that the UE indicated support for the RDS during the attach procedure.

10. The method as claimed in claim 1, further comprising creating, by the MME, a session management (SM) context on the SCEF during the attach procedure.

11. The method as claimed in claim 1, wherein the SCEF forwards the MO message to the NEF through a predefined interface.

12. The method as claimed in claim 11, wherein the NEF forwards the acknowledgement signal to the SCEF as per the SM context over the predefined interface.

13. The method as claimed in claim 12, wherein the SCEF delivers the acknowledgement signal to the UE via the MME after determining that the UE indicated support for the RDS during the attach procedure.

14. (canceled)

15. A system for managing a mobile originated (MO) message for a user equipment (UE) moving between a first network and a second network, the system comprising:
a receiving unit configured to receive a connection setup request from the UE and send an acknowledgment of the connection setup request to the UE;
a processing unit coupled to the receiving unit and is configured to:
determine if the UE is connected to the first network or to the second network;
when it is determined that the UE is connected to the first network, then performing following steps:
send, by the UE, an MO message to a session management function (SMF);
forward, by the SMF, the received MO message to a network exposure function (NEF);
forward, by the NEF, the MO message to an application function (AF);
send, by the AF, an acknowledgement signal to the NEF after receiving the MO message;
forward, by the NEF, the acknowledgement signal to the UE (102) via the SMF
when it is determined that the UE is attached to the second network, then performing following steps:
send, by the UE, an MO message to a mobility management entity (MME);
forward, by the MME, the received MO message to a service capability exposure function (SCEF);
forward, by the SCEF, the MO message to the NEF;
forward, by the NEF, the MO message to an application function AF;
send, by the AF, an acknowledgement signal to the NEF after receiving the MO message;
forward, by the NEF, the acknowledgement signal to the SCEF; and
deliver, by the SCEF, the acknowledgement signal to the UE via the MME.

16. (canceled)

17. (canceled)

18. The system as claimed in claim 15, further configured to create, by the SMF, a session management (SM) context on the NEF during the attach procedure.

19. The system as claimed in claim 15, further configured to search, by the NEF, an endpoint of the AF for forwarding the MO message to the AF, and wherein the NEF checks the SM context and a Non-Internet Protocol Data Delivery (NIDD) configuration mapping for searching the endpoint of the AF.

20. (canceled)

21. (canceled)

22. The system as claimed in claim 15, wherein the NEF forwards the acknowledgement signal to the UE via the SMF as per the SM context.

23. The system as claimed in claim 22, wherein the NEF forwards the acknowledgement signal to the UE after determining that the UE indicated support for the RDS during the attach procedure.

24. The system as claimed in claim 15, further configured to create, by the MME, a session management (SM) context on the SCEF during the attach procedure.

25. The system as claimed in claim 15, wherein the SCEF forwards the MO message to the NEF through a predefined interface.

26. The system as claimed in claim 25, wherein the NEF forwards the acknowledgement signal to the SCEF as per the SM context over the predefined interface.

27. The system as claimed in claim 26, wherein the SCEF delivers the acknowledgement signal to the UE via the MME after determining that the UE indicated support for the RDS during the attach procedure.

28. (canceled)

29. A user equipment (UE) moving between a first network and a second network, wherein the first network and the second network comprising one or more network elements for managing a mobile originated (MO) message for the UE, the one or more network elements configured for:
determining if the UE is connected to the first network or to the second network;
when it is determined that the UE is connected to the first network, the one or more network elements are configured for performing following steps:
receiving, from the UE, an MO message by a session management function (SMF);
forwarding, by the SMF, the received MO message to a network exposure function (NEF);
forwarding, by the NEF, the MO message to an application function (AF);
sending, by the AF, an acknowledgement signal to the NEF after receiving the MO message;
forwarding, by the NEF, the acknowledgement signal to the UE via the SMF;
when it is determined that the UE is attached to the second network, the one or more network elements are configured for performing following steps:
receiving, from the UE, an MO message by a mobility management entity (MME);
forwarding, by the MME, the received MO message to a service capability exposure function (SCEF);
forwarding, by the SCEF, the MO message to the NEF;
forwarding, by the NEF, the MO message to an application function AF;
sending, by the AF, an acknowledgement signal to the NEF after receiving the MO message;
forwarding, by the NEF, the acknowledgement signal to the SCEF; and
delivering, by the SCEF, the acknowledgement signal to the UE via the MME.

30. A computer program product comprising a non-transitory computer-readable medium comprising instructions that, when executed by one or more processors, cause the one or more processors to perform a method for managing a mobile originated (MO) message for a user equipment (UE) moving between a first network and a second network, the method comprising:
determining if the UE is connected to the first network or to the second network;
when it is determined that the UE is connected to the first network, then performing following steps:
sending, by the UE, an MO message to a session management function (SMF);
forwarding, by the SMF, the received MO message to a network exposure function (NEF);
forwarding, by the NEF, the MO message to an application function (AF);
sending, by the AF, an acknowledgement signal to the NEF after receiving the MO message;
forwarding, by the NEF, the acknowledgement signal to the UE via the SMF;
when it is determined that the UE is attached to the second network, then performing following steps:
sending, by the UE, an MO message to a mobility management entity (MME);
forwarding, by the MME, the received MO message to a service capability exposure function (SCEF);
forwarding, by the SCEF, the MO message to the NEF;
forwarding, by the NEF, the MO message to an application function AF;
sending, by the AF, an acknowledgement signal to the NEF after receiving the MO message;
forwarding, by the NEF, the acknowledgement signal to the SCEF; and
delivering, by the SCEF, the acknowledgement signal to the UE via the MME.
